(19) United States
(12) Patent Application Publication
(10) Pub. No.: US 2009/0057505 A1
(43) Pub. Date: Mar. 5, 2009

(54) FOLDABLE STAND TUBE

(76) Inventor: Chao-Hu Chen, Taichung Country (CN)

Correspondence Address: Chien-Hui Su, P. O. Box 70-121 Taichung, Taichung City, 40899, TW

(21) Appl. No.: 11/845,099

(22) Filed: Aug. 27, 2007

(51) Int. Cl. F16M 11/06

(52) U.S. Cl. 248/185.1; 403/102

(57) ABSTRACT

A foldable stand tube comprises an upper tube having an upper connecting portion and an upper pivot portion at one end thereof; the upper pivot portion enclosing an outer periphery of the upper tube; the upper connecting portion being hollowed and having a slit; a lower tube having a lower connecting portion and a lower pivot portion at one end thereof; the lower pivot portion enclosing the lower tube; an inner diameter of the upper connecting portion being greater than an outer diameter of the lower connecting portion so that the lower connecting portion being received into the upper connecting portion. The upper pivot portion is engaged to the lower pivot portion so that the upper pivot portion is rotatable with respect to the lower pivot portion and thus the upper tube is foldable with respect to the lower tube.

### FIELD OF THE INVENTION

The present invention relates to stand tubes, and particularly to a foldable stand tube which has a firm structure and a great strength. Furthermore the structure of the foldable stand tube is simple and can be operated easily.

### BACKGROUND OF THE INVENTION

In the stand tube of a bicycle, the stand tube has a straight tube and a clamping unit for locking a handle. The clamping unit is installed at a top of the straight tube. The straight tube includes an upper tube and a lower tube. A top of the lower tube has a base. A top and lateral side of the base have respective openings. A buckle unit is locked to a lower edge of the upper tube. The buckle unit inserts into the opening at a lateral side of the base and is pivoted thereto. Thus the upper tube is folded along the pivoted point. However, the prior art stand tube has weak structure and is unstable. Moreover, the locking force is very large. Therefore, it is not suitable for being used repeatedly. It is easily destroyed and is unstable. Furthermore the structure is loose, it will induce dangerous condition in driving.

### SUMMARY OF THE INVENTION

Accordingly, the primary object of the present invention is to provide a foldable stand tube which has a firm structure and a great strength. Furthermore the structure of the foldable stand tube is simple and can be operated easily. The stand tube of the present invention is especially used in a bicycle.

To achieve above objects, the present invention provides a foldable stand tube which comprises an upper tube having an upper connecting portion and an upper pivot portion at one end thereof; the upper pivot portion enclosing an outer periphery of the upper tube; the upper connecting portion being hollowed and having a slit; on end of the upper pivot portion having a through hole; a lower tube having a lower connecting portion and a lower pivot portion at one end thereof; the lower pivot portion enclosing the lower tube; an inner diameter of the upper connecting portion being greater than an outer diameter of the lower connecting portion so that the lower connecting portion being received into the upper connecting portion. The upper pivot portion is engaged to the lower pivot portion so that the upper pivot portion is pivotally rotatable with respect to the lower pivot portion and thus the upper tube is rotatable and foldable with respect to the lower tube. The various objects and advantages of the present invention will be more readily understood from the following detailed description when read in conjunction with the appended drawing.

### BRIEF DESCRIPTION OF THE DRAWINGS

FIG. 1 is an exploded perspective view of the foldable stand tube of the present invention.

FIG. 2 is a schematic perspective view of the foldable stand tube of the present invention.

FIG. 3 is a schematic view showing the folding operation of the present invention.

FIG. 4 is a schematic view showing the operation of the present invention.

FIG. 4A is a schematic view showing the first state of the safety unit of the present invention.

FIG. 4B is a schematic view showing the second state of the safety unit of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

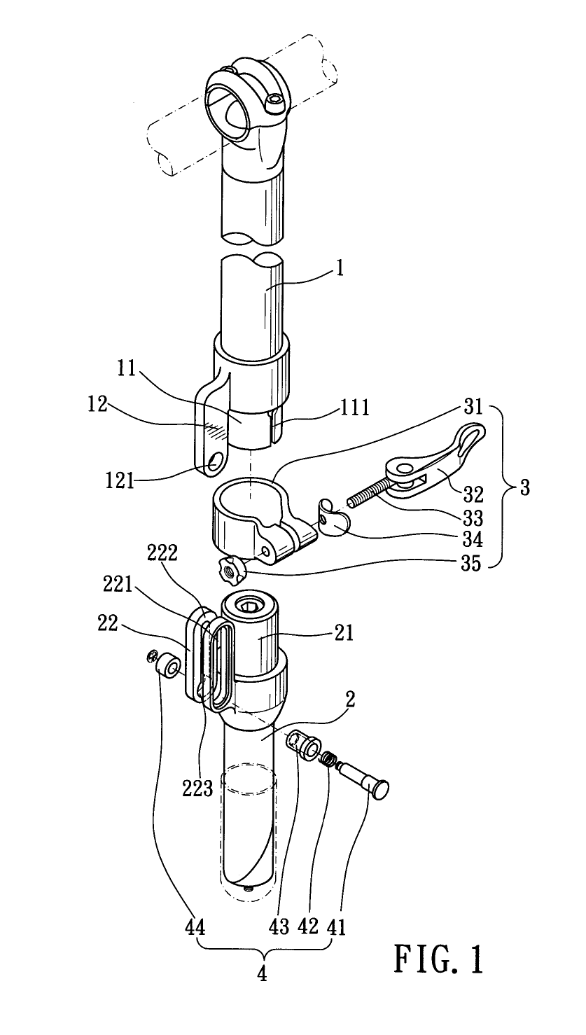

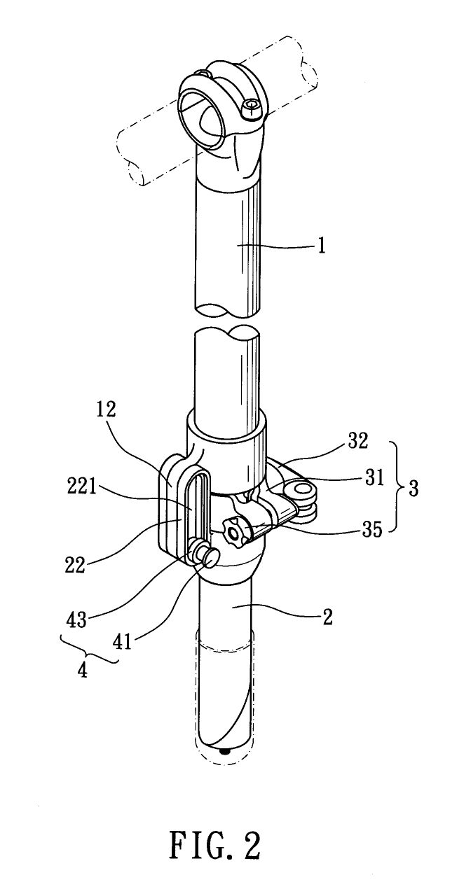

Referring to FIGS. 1 and 2, a foldable stand tube according to the present invention is illustrated. The present invention has the following elements.

An upper tube 1 has an upper connecting portion 11 and an upper pivot portion 12 at one end thereof. The upper pivot portion 12 encloses an outer periphery of the upper tube 1. The upper connecting portion 11 is hollowed and has a slit 111. On end of the upper pivot portion 12 has a through hole 121.

A lower tube 2 has a lower connecting portion 21 and a lower pivot portion 22 at one end thereof. The lower pivot portion 22 encloses the lower tube 2. The lower tube 2 is an approximate round cylindrical shape. An outer diameter of the upper connecting portion 11 is greater than an inner diameter of the lower connecting portion 21 so that the lower connecting portion 21 is received into the upper connecting portion 11. The lower pivot portion 22 is formed by two lower rings. Each lower ring has a sliding groove 221. A portion between the two lower rings is formed as a receiving space 222 for receiving the upper pivot portion 12. One end of one of the two sliding grooves 221 is formed with a limiting hole 223 a width of which is greater than a width of the sliding groove 221.

A retainer 3 serves for retaining the upper tube 1 and lower tube 2 as the upper connecting portion 11 is combined with the lower connecting portion 21. The retainer 3 includes a clamping ring 31, a driving unit 32, a screw rod 33, a pad 34 and a nut 33. The clamping ring 31 encloses the upper connecting portion 11. The screw rod 33 is installed to the driving unit 32 and is extended from the driving unit 32. The screw rod 33 passes through the pad 34, the clamping ring 31 and the nut 33 so as to combine the driving unit 32 to the clamping ring 31. The driving unit 32 can cause that the clamping ring tightly encloses the upper tube 1 so that the lower tube 2 is firmly secured into the upper tube 1.

A safety unit 4 includes a switch 41, a spring 42, a sliding unit 43, and a limiting unit 44. The sliding unit 43 has a hollow portion. The spring 42 is received in the hollow portion of the sliding unit 43. A shaft of the switch 41 passes through the spring 42 and seals one end of the sliding unit 43. The limiting unit 44 seals another end of the sliding unit 43. In assembly, safety unit 44 is received in the sliding grooves 221 of the lower pivot portion 22 and the through hole 121 of the upper pivot portion 12.

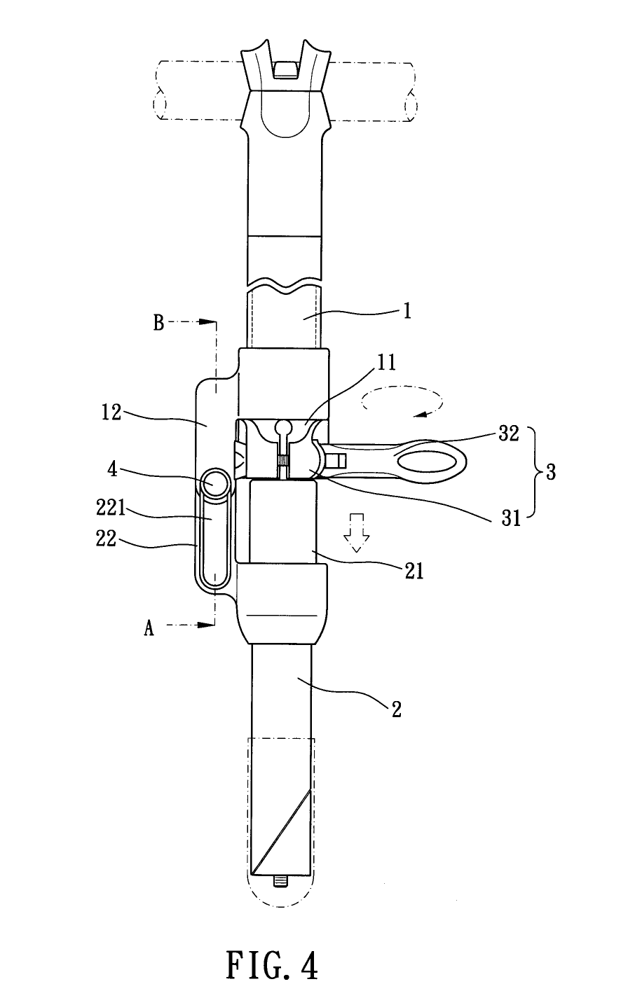

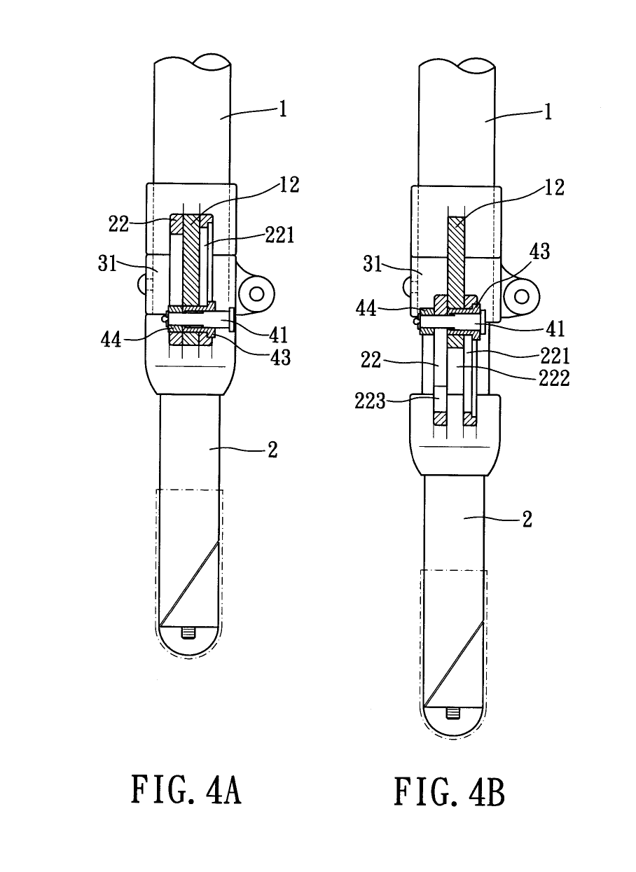

Referring to FIGS. 4A and 4B, the safety unit 44 can be retained in two states. In FIG. 4A, the safety unit 44 passes through the two sliding grooves 221 and the through hole 121 and locates in the limiting hole 223. The switch 41 is not drawn outwards. At this state, the upper tube 1 is rotatable with respect to the lower tube 2. In another state illustrated in FIG. 4B, the safety unit 44 does not locate in the limiting hole 223 and the switch 41 is drawn out so that one lower ring is clamped between the limiting unit 44 and the sliding unit 43.

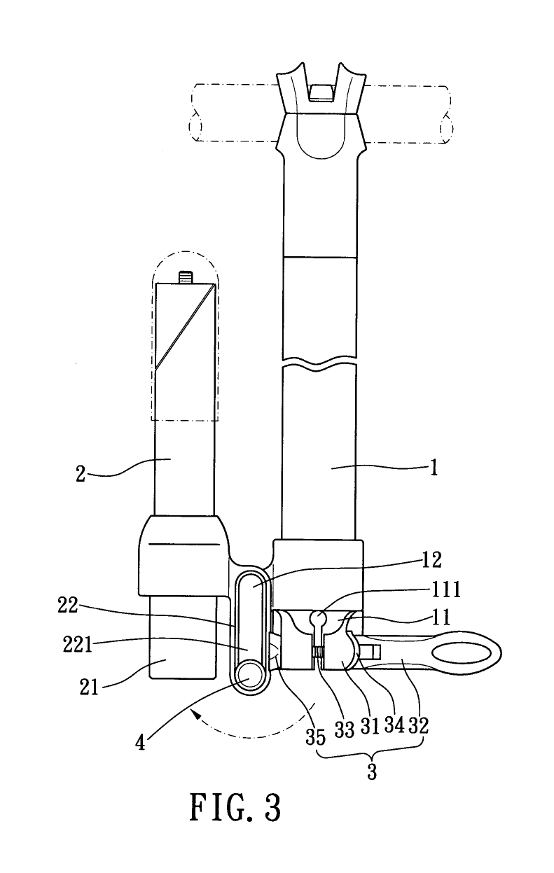

Referring to FIGS. 3 and 4, the operation of the present invention is illustrated. FIG. 3 shows the folding operation of the present invention, in that the safety unit 44 is in a tightly combined structure (see the state illustrated in FIG. 4A), the upper tube 1 is rotatable with respect to the lower tube 2 along the lower tube 2. Referring to FIG. 4, when the upper tube 1 rotates to be in line with the upper tube 1. The upper connecting portion 11 is inserted into the hollow space of the lower connecting portion 21. Then the driving unit 32 is screwed to cause the clamping ring 31 to clamp the upper tube 1 tightly so that the upper tube 1 is tightly engaged with the lower tube 2.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A foldable stand tube comprising:
an upper tube having an upper connecting portion and an upper pivot portion at one end thereof; the upper pivot portion enclosing an outer periphery of the upper tube; the upper connecting portion being hollowed and having a slit;
a lower tube having a lower connecting portion and a lower pivot portion at one end thereof; the lower pivot portion enclosing the lower tube; an outer diameter of the upper connecting portion being greater than an inner diameter of the lower connecting portion so that the lower connecting portion being received into the upper connecting portion;
wherein the upper pivot portion is engaged to the lower pivot portion so that the upper pivot portion is pivotally rotatable with respect to the lower pivot portion and thus the upper tube is rotatable and foldable with respect to the lower tube.

2. The foldable stand tube as claimed in claim 1, wherein the lower pivot portion is formed by two lower rings; each lower ring has a sliding groove; a portion between the two lower rings being formed as a receiving space for receiving the upper pivot portion.

3. The foldable stand tube as claimed in claim 1, wherein a retainer for retaining the upper tube and lower tube as the upper connecting portion is combined with the lower connecting portion.

4. The foldable stand tube as claimed in claim 1, wherein the retainer includes a clamping ring, a driving unit, a screw rod, a pad and a nut; the clamping ring encloses the upper connecting portion; the screw rod is installed to the driving unit and is extended from the driving unit; the screw rod passes through the pad, the clamping ring and the nut so as to combine the driving unit to the clamping ring; and the driving unit causes that the clamping ring tightly enclose the upper tube so that the lower tube is firmly secured into the upper tube.

5. The foldable stand tube as claimed in claim 2, wherein on end of the upper pivot portion having a through hole; each ring has a sliding groove; and one end of one of the two sliding grooves being formed as a limiting hole which is greater than a width of the sliding groove.

6. The foldable stand tube as claimed in claim 5, further comprising: a safety unit includes a switch, a spring, a sliding unit, and a limiting unit; the sliding unit has a hollow portion; the spring is received in the hollow portion of the sliding unit; a shaft of the switch passes through the spring and seal one end of the sliding unit; the limiting unit seals another end of the sliding unit; in assembly, safety unit is received in the sliding grooves of the lower pivot portion and the through hole of the upper pivot portion.
